(19) United States
(12) Patent Application Publication
(10) Pub. No.: US 2010/0318424 A1
(43) Pub. Date: Dec. 16, 2010

(54) System for Correlating Physiological and Environmental Conditions

(75) Inventor: Amy E. LaValle, New Rochelle, NY (US)

Correspondence Address: CONLEY ROSE, P.C., 5601 GRANITE PARKWAY, SUITE 750, PLANO, TX, 75024, US

(73) Assignee: L2LA, LLC, New Rochelle, NY (US)

(21) Appl. No.: 12/814,357

(22) Filed: Jun. 11, 2010

Related U.S. Application Data
(60) Provisional application No. 61/182,187, filed on Jun. 12, 2009.

(51) Int. Cl. G06F 17/30; G06F 3/048; G06Q 30/00

(52) U.S. Cl. 705/14.58; 707/812; 715/764; 707/769; 707/E17.009; 707/E17.014

(57) ABSTRACT

A system comprising a storage device configured to store temporal information, geographical information, physiological information, and environmental information associated with a user, and a server coupled to the storage device and configured to correlate at least some of the physiological information and at least some of the environmental information to obtain relationship information corresponding to a relationship between the physiological information and the environmental information over a time period.

### CROSS-REFERENCE TO RELATED APPLICATIONS

The present application claims priority to U.S. Provisional Patent Application No. 61/182,187 filed Jun. 12, 2009 by Amy E. LaValle and entitled “System for Correlating Physiological and Environmental Conditions,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Clinical tests and tools may not provide sufficient information for effective diagnosis and treatment of some medical conditions or illnesses. For instance, laboratory tests can provide limited information regarding the causes or triggers for some chronic conditions, such as migraine, arthritis, or other chronic pain disorders. To improve treatment of such medical conditions, physicians may collect and assess medical information recorded by the patients in a diary over time. The diary typically records physiological information, including symptoms related to the examined medical condition and reactions to medication, and other health information or activities for the patient. The physicians can analyze the content of the diary to correlate the physiological information to the patient's unique health conditions or activities, for instance to draw conclusions about which health conditions or activities might trigger the symptoms. Physicians may also correlate the physiological information to environmental information, such as weather conditions in the patient's geographical location, to find additional triggers. The diary may also provide the physicians with symptom patterns, such as pain intensity or frequency over time.

### SUMMARY

In one embodiment, the disclosure includes a system comprising a storage device configured to store temporal information, geographical information, physiological information, and environmental information associated with a user, and a server coupled to the storage device and configured to correlate at least some of the physiological information and at least some of the environmental information to obtain relationship information corresponding to a relationship between the physiological information and the environmental information over a time period.

In another embodiment, the disclosure includes A network component comprising at least one processor coupled to a memory and configured to obtain temporal information, geographical information, and physiological information associated with a user, obtain environmental information associated with the temporal information and geographical information from an environmental tracking service, store the physiological information and the environmental information in a database, correlate the physiological information with environmental information to obtain relationship information corresponding to a relationship between the physiological information and the environmental information over a time period, and generate a report comprising the relationship information.

In yet another embodiment, the disclosure includes A method of creating an electronic medical research database comprising collecting geographical location data and physiological data for a plurality of human subjects over a time period, wherein the physiological data comprises symptom data corresponding to a physiological condition, collecting environmental data associated with the geographical location data over the time period from an electronic environmental tracking service, storing the physiological data and the environmental data in a database, and correlating the physiological data with the environmental data based on criteria defined by the human subjects, a physician, a medical researcher, or an administrator, or combinations thereof, to generate relationship information corresponding to a relationship between the physiological information and the environmental information over a time period.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of one embodiment of electronic diary system.

FIG. 2 is a flowchart of an embodiment of electronic diary management method.

FIG. 3 is a flowchart of another embodiment of electronic diary management method.

FIG. 4 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a system and method for providing and maintaining an electronic diary for medical conditions, such as migraine headaches or chronic pain. The electronic diary may comprise physiological information and environmental information that may be correlated with each other. The electronic diary may also comprise geographical information, which may be correlated with the physiological information and environmental information. The electronic diary may be maintained using a computerized system or server, for instance on the Internet. The physiological information and the geographical information may be entered by the patient and then stored, for instance in a database coupled to the server. The environmental information may also be entered by the patient and/or may be obtained from external sources, e.g. based on the patient's geographical location, and stored by the server. The stored information may be used to generate reports or accessed for medical prognoses and diagnoses. Additionally, information from a plurality of patients may be integrated, correlated, and used to determine and predict physiological symptoms based on environmental patterns.

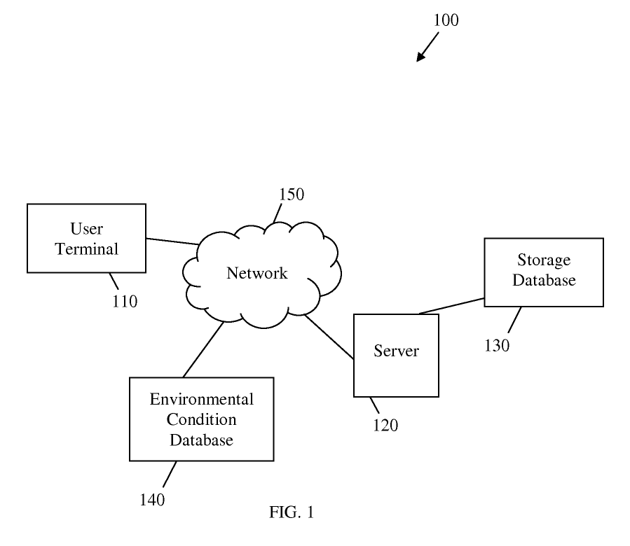

FIG. 1 illustrates an embodiment of an electronic diary system 100, which may be used to maintain information about a medical condition. The electronic diary system 100 may comprise at least one user terminal 110, a server 120, a storage database 130, an environmental condition database 140, and a network 150. The user terminal 110 may be any device capable of communicating with the server 120. For instance, the user terminal 110 may be coupled to the server 120 via the network 150 using a fixed link, such as an electrical or a fiber optic cable, which may implement Ethernet, Asynchronous Transfer Mode (ATM), Internet Protocol (IP), or any other suitable protocol. The user terminal 110 may be a fixed device, including a personal computer (PC) such as a desktop computer, a telephone such as a voice over IP (VoIP) telephone, or a set top box. In some embodiments, the user terminal 110 may communicate with the server 120 via a public switched telephone network (PSTN). Alternatively, the user terminal 110 may communicate with the server 120 using a wireless link between the user terminal 110 and the network 150, such an Institute of Electrical and Electronic Engineering (IEEE) 802.11 link, a BLUETOOTH link, a Worldwide Interoperability for Microwave Access (WiMAX) link, or any other communication link established using wireless technology. For example, the user terminal 110 may be a mobile phone, a personal digital assistant (PDA), a portable computer, or any other wireless device. As such, the user terminal 110 may comprise an infrared port, a Bluetooth interface, an IEEE 802.11 compliant wireless interface, or any other wireless communication system that enables the user terminal 110 to communicate wirelessly with the server 120. Further in the alternative, the user terminal 110 may be a portable device, such as a laptop computer or a wireless phone, which may use a serial combination of wireless and fixed links to communicate with the server 120. Although one user terminal 110 is shown in FIG. 1, the electronic diary system 100 may comprise a plurality of user terminals 110 in communication with the server 120.

The server 120 may be any device, component, or network configured to maintain electronic diary information. The server 120 may receive electronic diary information from the user terminal 110, the storage database 130, and/or the environmental condition database 140 via the network 150, and may send any requested information to the user terminal 110. For instance, the server 120 may obtain environmental information from the environmental condition database 140, e.g. periodically or as needed. Additionally, the electronic diary information may be entered by a patient using an electronic form, e.g. on the user terminal 110. The electronic diary information may also be viewed or printed by the patient or a physician in the form of a report using the terminal 110. The server 120 may process the electronic diary information, for instance to correlate some information or generate reports, based on a request received from the user terminal 110. The server 120 may then send a reply comprising the processed information to the user terminal 110. The server 120 may also be coupled to the storage database 130 and may store the received information in the storage database 130.

The storage database 130 may be any device, component, or network configured to store electronic diary information. For instance, the storage database 130 may comprise a hard drive, a disk drive, a tape drive, flash drive, or any other memory device. In other embodiments, the server 120 may comprise the storage database 130 or may communicate with the storage database 130 via the network 150.

The environmental condition database 140 may be any device, component, or network configured to generate, obtain, or maintain the environmental information. For example, the environmental condition database 140 may be a government or commercial database that obtains and stores environmental information, such as temperature, barometric pressure, humidity, wind, precipitation, air quality (particulate, allergen, etc. type and/or density) and the like for specific times of day and specific locations. The environmental condition database 150 may be in the form of, or accessible via, a website, such as www.weather.com or www.noaa.gov.

The network 150 may be any type of network that exchanges data frames or packets between the user terminal 110, the server 120, and the environmental condition database 140. For example, the network 140 may be a Packet Switched Network (PSN), an intranet, the Internet, a local area network (LAN), a metropolitan area network (MAN), or a wide area network (WAN). Alternatively, the network 140 may be an Ethernet transport network, a backbone network, an access network, an optical network, a wire-line network, an IEEE 802 standard network, a wireless network, or any other network.

In an embodiment, the electronic diary information maintained by the server 120 may comprise physiological information related to a pain condition, illness, or any other medical condition. The physiological information may comprise symptom conditions, health conditions, physical conditions, or other physiological data about the patient. For example, in the case of a headache or pain condition, the physiological information may include the time that the pain starts, duration or the time that the pain stops, type of headache (e.g. migraine or tension), symptoms prior to pain (prodrome), pain intensity, other symptoms (e.g. aura, nausea, vomiting, etc.), medication, pain triggers (e.g. caffeine, sleep deprivation, etc.), activities, comments, or combinations thereof. Physiological conditions may also comprise information about disorders and illnesses such as allergies or asthma. The physiological data may also include patient temperature, weight, height, age, appetite, blood glucose levels, etc. In some embodiments, the electronic diary may also comprise information about patient activities or habits (e.g. sleep patterns, diet, exercise, etc.) and/or patient's comments. The physiological information may be entered by a patient on the user terminal 110.

Additionally, the electronic diary information may comprise environmental information. The environmental information may be maintained by the environmental condition database 140 and obtained by the server 120. The environmental information may comprise weather conditions, atmospheric conditions, or other environmental data. For example, the environmental information may include temperature, barometric pressure, humidity, allergens, pollutants (e.g. fine particulates, black carbon, nitrogen, sulfur dioxide, pollen, allergen, etc. density), moon phase, solar conditions, or combinations thereof. Such environmental conditions may have direct or indirect effects on the physiological conditions of the patient, such as in the case of headaches, chronic pain, or allergies. The environmental conditions may also comprise recent (e.g. about 1, 4, 8, 12, 24, 48, or 72 hour) changes in any of these conditions. In some embodiments, the user terminal 110 may comprise a sensor for detecting environmental conditions. For example, the sensor may be a thermometer, a barometer, a hygrometer, a microelectromechanical system (MEMS) sensor, or other sensor for detecting allergens or pollutants in the air.

Additionally, the electronic diary information may comprise geographical information, which may comprise location, elevation, area type, or other geographical data. For example, the geographical information may comprise a city zip code or a local address entered by the patient. The geographical information may be entered by a patient on the user terminal 110. In some embodiments, the user terminal 110 may comprise satellite, wireless signal triangulation, and/or global positioning system (GPS) technology for automatically tracking the patient's geographic location.

In an embodiment, the electronic diary information may be entered using an application or a user interface, for instance a web interface, on the user terminal 110. The electronic diary information may be entered on a daily, weekly, monthly, or as needed basis. The date and time may be entered with the electronic diary information or recorded automatically. In an embodiment, the user interface may comprise a form, a calendar, a checkbox, a menu, and/or similar visual interface components, which may facilitate data display and/or entry. The user interface may comprise a reminder feature, which may prompt the user, e.g. patient, to enter the information. Alternatively, the user interface may assume that there are no symptoms if the user does not make an entry within one of the aforementioned amounts of time, and update the electronic diary information accordingly. The user interface may also allow duplicate data for subsequent entries, such as using copy and paste functions. At least a portion of the interface may be configured similar to the forms found in the references below, which are incorporated herein by reference as if reproduced in their entirety.

The interface may be used to store and maintain the information at a centralized location, e.g. server 120 and/or storage database 130. The information may be printed and/or stored locally, for instance upon completing data entry. The patient's information may be secured by providing restricted access to the patient and/or a physician, for instance using a user name and password. In an embodiment, the user interface may also display links and/or downloads to information and educational resources that may be relevant to the patient's medical condition. Additionally, the user interface may display ads or links that may be relevant to the patient's interests or medical conditions, such as pharmaceutical ads, health spa ads, information from physicians and health care providers, etc.

The electronic diary information may be correlated at periodic internals. For instance, the electronic diary information may be correlated in response to a request or query from an authorized user, such as the patient or a physician. Alternatively, the electronic diary information may be automatically correlated periodically or continuously, and the user automatically notified when statistically significant correlations are found. For instance, at least some of the user's physiological information may be compared with at least some of the environmental information in the user's geographic location from the same time period to determine whether any statistically significant patterns exist. Various levels of statistical significance may exist within the art, and, as such, the level of statistical significance used herein may be defined by the user or a network administrator. Alternatively, various portions of the electronic diary information may be compared to each other in an attempt to determine if any statistically significant patterns exist. If statistically significant patterns exist, then the pattern may be used to define a correlation.

In an embodiment, at least a portion of the user's physiological information (e.g. pain intensity) may be correlated with at least a portion of the user's environmental information (e.g. temperature or recent change in temperature) in the form of a correlation table or a chart. The correlated information, which may be stored in the storage database 130, may be used to generate reports, downloaded electronically, emailed, texted, and/or printed. Such information may be used to observe the effect of an environmental condition on the occurrence of a symptom and, thus, shield the patient from any environmental aspects that may contribute or trigger his medical condition.

In an embodiment, the physiological information may comprise migraine headache intensity and frequency over a time period (e.g. a few days, weeks, months, or years), and the environmental information may comprise daily readings of temperature, barometric pressure, allergens, or combinations thereof over the same time period. Such physiological and environmental information may be correlated and displayed based on a query by the user. For example, the user may enter a request, via the user interface, to obtain a table or chart that indicates pain intensity vs. temperature readings over a specified time period. The time period or the dates of the data points may also be referred to as temporal information. Similarly, the user may request reports of pain intensity vs. barometric pressure readings, allergens readings, or combinations of the different environmental information over a period of time. Such information may be useful for effective diagnosis and treatment of a migraine headache condition, e.g. by identifying environmental factors that may have positive or negative effects on pain occurrence and intensity. Additionally or alternatively, the physiological and environmental information may be correlated and saved based on pre-defined criteria that may be set by the user, e.g. a patient or a physician. The stored correlated information may be retrieved at any time, e.g. in the form of reports, and used for diagnosis and treatment.

In an embodiment, the correlated physiological and environmental information may be used to predict future physiological information, such as future migraine or pain conditions. As such, the correlated physiological and environmental information may be used to establish a relationship or pattern between environmental conditions and physiological conditions. For example, future migraine headache occurrences and/or intensity may be predicted based on predicted future weather forecast, such as temperature, barometric pressure, or allergens. Accordingly, if elevated pain intensity is previously recorded for relatively high temperature or barometric readings, future elevated pain intensity may be expected for future expected similar high levels of temperature or barometric pressure. The predicted future physiological information or conditions may be processed and provided to the user when it is discovered (e.g. real-time), based on request (e.g. user query), or pre-defined criteria (e.g. scheduled queries), for example in the form of reports.

In an embodiment, a physician may be authorized to access the physiological and environmental information in the electronic diary of a patient without the patient's identification data (e.g. name, address, etc.) and may use the authorized information for clinical studies. Further, some authorized users, such as medical researchers, may request correlated electronic diary information for a plurality of patients. For example, a plurality of physiological information and environmental information corresponding to a plurality of users may be correlated with geographical information (e.g. zip code) or other information and reported. The correlated information may be used for statistical analysis, for instance for a certain demographic, to promote medical research and improved treatment.

In an embodiment, at least some of the electronic diary information may be tracked to assess the patient's health or treatment progress and provide feedback. For example, information such as symptoms, pain duration, medication, or other aspects of the patient's medical condition may be tracked and compared with the patient's previous records or other patients' records to evaluate treatment progress and provide health or behavioral modification suggestions. The patient's medical condition may be automatically tracked to generate prescheduled reports, for instance by a function of the server 120.

In an embodiment, a plurality of patients may connect with each other and/or share at least some of their electronic diary information, for example via the electronic diary system 100. Patients may use the user interface to search for other patients with similar physiological information and/or environmental information and may contact each other, for example via email, text message, or instant message. Additionally or alternatively, the patients may use the user interface to communicate, for instance via an online chatting application or blog.

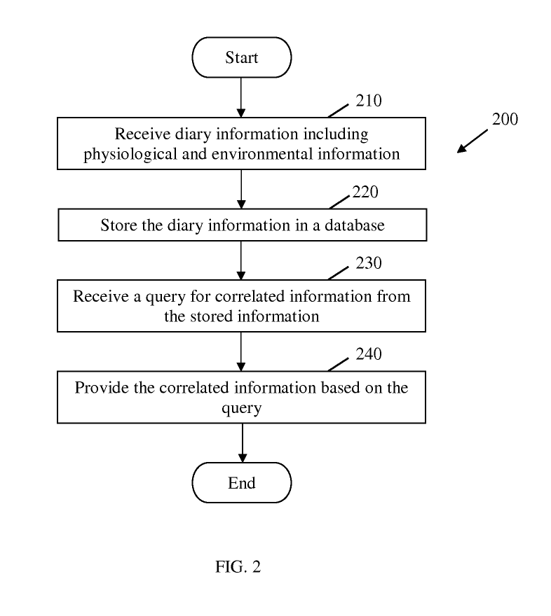

FIG. 2 illustrates an embodiment of an electronic diary management method 200 for maintaining a centralized electronic diary, which may be implemented using the electronic diary system 100. The method 200 may begin at block 210, where diary information including physiological information and environmental information may be received. For instance, the method 200 may prompt a patient or a user to enter the information using a user interface, such as an online form. The method 200 may also request a password from the user before allowing the user to enter the information. At block 220, the method 200 may store the diary information in a database, for example in a file format in the storage database 130. At block 230, the method 200 may receive a query for correlated information from the stored information. For instance, the user may request correlated physiological information, environmental information, geographical information, or combinations thereof from at least a portion of the stored information. The information may be requested using a request form or menu selection, or other available query tools available to the user. Alternatively, a request may be automatically generated when a statistically significant pattern is discovered. At block 240, the method 200 may provide the correlated information based on the request, for example in a table and/or a chart. For instance, the requested information may be sent to the user via the user interface, text message, or email. The method 200 may then end.

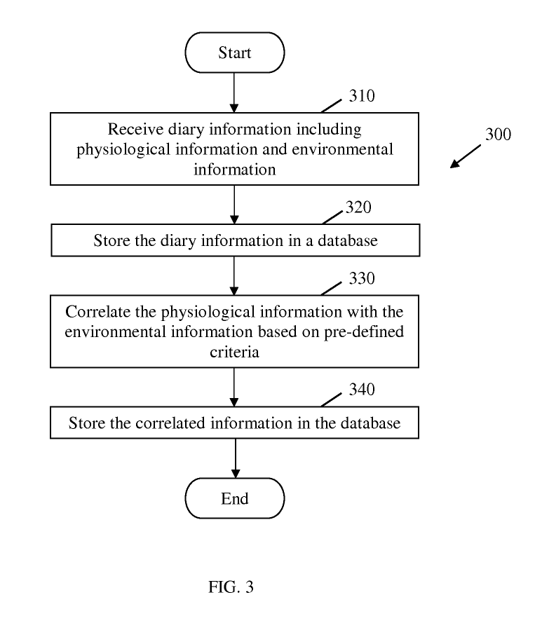

FIG. 3 illustrates another embodiment of an electronic diary management method 300 for maintaining a centralized electronic diary, for example using the electronic diary system 100. The method 300 may begin at block 310, where diary information including physiological information and environmental information may be received. For instance, a patient or a user that may be subscribed to a website on the Internet may enter the physiological information using a user interface, e.g. a form on the website and/or a mobile device application. The environmental information may be obtained from an environmental tracking server, e.g. environmental condition database 140. At block 320, the method 300 may store the diary information in a database, e.g. the storage database 130. The database may comprise both the physiological information from the user and the environmental information from the environmental tracking server. At block 330, the method 300 may correlate the physiological information with the environmental information based on pre-defined criteria. The pre-defined criteria may comprise queries that may be set or programmed previously by the user, e.g. the patient or a physician. For instance, the previously sent queries may be stored in the database and triggered when new information is entered by the user or as scheduled. Alternatively, the physiological information and the environmental information may be correlated by discovering a statistically significant pattern between the physiological information and the environmental information. At block 340, the physiological information with the environmental information may be stored in the database. As such, the correlated information may be displayed upon request or as scheduled in the form of reports, charts, tables, or other forms. The method 300 may then end.

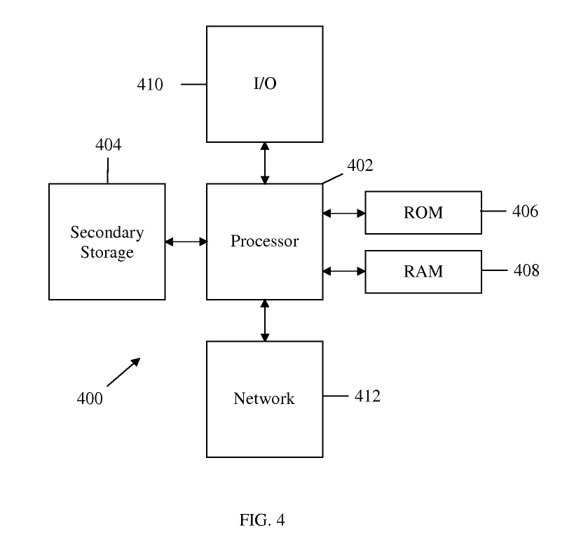

FIG. 4 illustrates a typical, general-purpose network component 400 suitable for implementing one or more embodiments of the components disclosed herein. The network component 400 includes a processor 402 (which may be referred to as a central processor unit or CPU) that is in communication with memory devices including secondary storage 404, read only memory (ROM) 406, random access memory (RAM) 408, input/output (I/O) devices 410, and network connectivity devices 412. The processor 402 may be implemented as one or more CPU chips, or may be part of one or more application specific integrated circuits (ASICs).

The secondary storage 404 is typically comprised of one or more disk drives or tape drives and is used for non-volatile storage of data and as an over-flow data storage device if RAM 408 is not large enough to hold all working data. Secondary storage 404 may be used to store programs that are loaded into RAM 408 when such programs are selected for execution. The ROM 406 is used to store instructions and perhaps data that are read during program execution. ROM 406 is a non-volatile memory device that typically has a small memory capacity relative to the larger memory capacity of secondary storage 404. The RAM 408 is used to store volatile data and perhaps to store instructions. Access to both ROM 406 and RAM 408 is typically faster than to secondary storage 404.

The following references are incorporated by reference:
1. “Weather and air pollution as triggers of severe headaches,” Mukamal et al., Neurology. 2009; 72: 922-927, http://www.neurology.org/cgi/content/full/72/10/922
2. http://www.achenet.org/tools/diaries/index.asp
3. http://www.headaches.org/pdf/headachediary.pdf
4. http://whs.berkeley.edu/home/healthtopics/pdf/diary.pdf
5. http://www.migrainehelp.com/pdf/migrainediary.pdf
6. http://webmd.com/migraines-headaches/guide/tension-headache-diary
7. http://ae.medseek.com/healthwise/media/pdf/hw/form_aa164142.pdf
8. http://www.maxalt.com/maxaltconsumer/documents/diary.pdf
9. http://www.replax.com/migrain-diary.aspx
10. http://headaches.about.com/cs/diagnosis/a/diary.htm
11. http://www.americangeriatrics.org/education/daily-pain-diary.pdf
12. http://www.painfoundation.org/publications/targetnotebook.pdf
13. http://www.painawareness.org/paindiary.pdf
14. http://www.health.com/health/static/hw/media/pdf/hw/form_ty6785.pdf
15. http://www.cancer.org/downloads/MON/pain_diary.pdf
16. https://www.caremark.com/imagebank/health_diaries/dailypaindiary.pdf
17. http://myheadachediary.com
18. http://www.fertilityfriend.com
19. Soundtells™ Headache Diary for Pocket PC/Windows Mobile with touch screen
20. http://www.weather.com/activities/health/achesandpains/?from=breadcrumbs
21. http://www.weather.com/activities/health/achesandpains/achesandpains101/index.html
22. http://www.ehow.com/list_{—}6184366_physical-effects-barometric-pressure-changes.html
23. http://www.ehow.com/facts_{—}5892132_headache-barometric-pressure-treatment.html
24. http://www.webmd.com/allergies/features/the-weather-wreaking-havoc-on-health
25. http://www.associatedcontent.com/article/30480/migraine_headaches_and_barometric_pressure.html?cat=5
26. The following U.S. patents and Published Patent Applications:

| U.S. Patent/Published | |
|---|---|
| Application Number | Title |
| 3,999,050 | Electronic Diary |
| 4,162,610 | Electronic Calendar And Diary |
| 4,731,726 | Patient-Operated Glucose Monitor And Diabetes Management System |
| RE 32,655 | Electronic Calendar And Diary |
| 4,847,760 | Electronic Device For Storing Personal Information |
| 4,975,842 | Electronic Patient Diary And Patient Monitoring Process |
| 5,023,851 | Method For Presenting Electronic Calendar Information In An |
| | Interactive Information Handling System |
| 5,207,580 | Tailored Health-Related Behavior Change And Adherence Aid System |
| 5,347,579 | Personal Computer Diary |
| 5,524,645 | Objective Measurement Tool For Evaluating Medical Therapy |
| | Outcome In Accordance With Quantified Physical Therapy Data |
| 5,653,739 | Electronic Pain Feedback System And Method |
| 5,873,900 | Electronic Pain Feedback System And Method |
| 6,039,688 | Therapeutic Behavior Modification Program, Compliance Monitoring |
| | And Feedback System |
| 6,168,563 | Remote Health Monitoring And Maintenance System |
| 6,168,569 | Apparatus And Method For Relating Pain And Activity Of A Patient |
| 2008/0021288 | Method And System For Generating Personalized Health Information |
| | With Accommodation For Consumer Health Terminology |
| 6,529,195 | Pain Migration Tracking And Display Method |
| 6,856,315 | Pain Migration Tracking And Display Method |
| 2003/0144829 | System And Method For Sensing And Evaluating Physiological |
| | Parameters And Modeling An Adaptable Predictive Analysis For |
| | Symptoms |

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A system comprising:
a storage device configured to store temporal information, geographical information, physiological information, and environmental information associated with a user; and
a server coupled to the storage device and configured to correlate at least some of the physiological information and at least some of the environmental information to obtain relationship information corresponding to a relationship between the physiological information and the environmental information over a time period.

2. The system of claim 1 further comprising an environmental condition database configured to collect environmental information from a remote environmental tracking service.

3. The system of claim 2 further comprising a user interface configured to accept physiological information from the user and provide the relationship information to the user.

4. The system of claim 3, wherein the user interface comprises a website.

5. The system of claim 3, wherein the user interface comprises a mobile application.

6. The system of claim 3, wherein the user interface is configured to display advertisements relevant to the temporal information, the geographical information, the physiological information, the environmental information, or combinations thereof.

7. The system of claim 1, wherein the physiological information comprises symptom information related to a physiological condition.

8. The system of claim 7, wherein the symptom information comprises pain intensity.

9. The system of claim 1, wherein the environmental information comprises temperature, barometric pressure, precipitation, humidity, air quality, pollutant composition, pollutant density, allergen composition, allergen density, or combinations thereof.

10. The system of claim 1, wherein the relationship information comprises pain intensity versus temperature, barometric pressure, precipitation, humidity, air quality, pollutant composition, pollutant density, allergen composition, allergen density, or combinations thereof.

11. A network component comprising:
at least one processor coupled to a memory and configured to:
obtain temporal information, geographical information, and physiological information associated with a user;
obtain environmental information associated with the temporal information and geographical information from an environmental tracking service;
store the physiological information and the environmental information in a database;
correlate the physiological information with environmental information to obtain relationship information corresponding to a relationship between the physiological information and the environmental information over a time period; and
generate a report comprising the relationship information.

12. The network component of claim 11, wherein the physiological information and the environmental information is correlated based on a pre-defined query that is stored in the database.

13. The network component of claim 12, wherein the physiological information and the environmental information are correlated when new information is added to the database according to a schedule, or both.

14. The network component of claim 11, wherein the physiological information and the environmental information is correlated by determining statistically significant patterns in the relationship information.

15. The network component of claim 11, wherein the physiological information is provided using a form on a user interface, and wherein the report is displayed by the user interface in the form of a table or chart.

16. The network component of claim 11, wherein the processor is further configured to:
obtain forecasted environmental information;
predict future physiological information using the forecasted environmental information and the relationship information, and
generate a report comprising the future physiological information.

17. A method of creating an electronic medical research database comprising:
collecting geographical location data and physiological data for a plurality of human subjects over a time period, wherein the physiological data comprises symptom data corresponding to a physiological condition;
collecting environmental data associated with the geographical location data over the time period from an electronic environmental tracking service;
storing the physiological data and the environmental data in a database; and
correlating the physiological data with the environmental data based on criteria defined by the human subjects, a physician, a medical researcher, an administrator, or combinations thereof, to generate relationship information corresponding to a relationship between the physiological information and the environmental information over a time period.

18. The method of claim 17, wherein the human subjects connect with each other and share at least some of the physiological information.

19. The method of claim 17, further comprising obtaining forecasted environmental information; and
predicting future physiological information using the forecasted environmental information and the relationship information.

20. The method of claim 19, further comprising generating a report comprising the future physiological information.
